(19) United States
(12) Patent Application Publication
(10) Pub. No.: US 2002/0023011 A1
(43) Pub. Date: Feb. 21, 2002

(54) Online shopping system presenting evaluations of merchandises and services by clients

(75) Inventor: Akemi Hatayama, Tokyo (JP)

Correspondence Address: Paul-J. Esatto, Jr., Scully, Scott, Murphy & Presser, 400 Garden City Plaza, Garden City, NY, 11530, US

(73) Assignee: NEC Corporation, Tokyo (JP)

(21) Appl. No.: 09/825,190

(22) Filed: Apr. 3, 2001

(30) Foreign Application Priority Data
Mar. 4, 2000 (JP) 2000-101488

(51) Int. Cl. G06F 17/60

(52) U.S. Cl. 705/26

(57) ABSTRACT

An object of the present invention is to present a situation allowing the clients to judge the evaluation on the merchandise appropriately. An online shopping system having a server device for supplying merchandise or presenting service through a communication line, and a client device for purchasing the merchandise sold or the service presented from the server device through the communication line. The shopping system comprises means for acquiring evaluation of the merchandise or service by the client having purchased the sold merchandise or presented service, and means for presenting the acquired evaluation or data based on the evaluation to other client, in which the evaluation is presented by the presenting means before the other client purchases the merchandise to be sold or the service to be presented from the server device through the communication line.

### BACKGROUND OF THE INVENTION

1. Technical Field of the Invention

The present invention relates to an online shopping system, server device, client device, and information management device.

2. Description of the Prior Art

Hitherto, along with spread of the Internet and other communication channels for connecting computers mutually by using public telephone line, ISDN (integrated services digital network in Japan) and others of personal computers and the like, the online shopping system known as the Internet shopping is being developed to purchase merchandise or service through the network such as the Internet.

In the online shopping, the supplier of the merchandise or service opens a home page by using a computer as a server device, and exhibits a catalog of products on the home page, and receives purchase orders of merchandise through the Internet just like mail order.

At the server device side, aside from the article and the corresponding article number, a catalog including the article number 1 “hat” and description of merchandise presented at the server device side as shown in FIG. 8 is presented, or as disclosed in JP 10-269049 A (1998), for example, reference materials for judging purchase of merchandise is presented to the clients by displaying the access frequency by clients, merchandise sales amount, merchandise quality, etc.

The client or would-be purchaser of merchandise access the home page operated by the supplier of the merchandise through the Internet from the computer or the client device installed at home or in office, and refers to the catalog or merchandise quality displayed on the home page, and orders a desired article, then the article will be later distributed to the purchaser of article by postal mail or the like from the supplier.

In the prior art, the merchandise description, client access frequency, merchandise sales amount and other information are displayed at the server device side, but it merely shows the evaluation before the client purchases the merchandise, and the evaluation of the merchandise by the client actually having purchased the merchandise cannot be presented to other clients, and the satisfaction of clients about the actual merchandise is not known to other clients. In addition, the merchandise description is presented by the server device of the merchandise supplier, and it has been demanded to improve so that the reliability of the description may guaranteed.

### SUMMARY OF THE INVENTION

It is therefore, an object of the present invention to provide an online shopping system capable of presenting the evaluation of the merchandise by the client having actually purchased the merchandise to other clients.

That is, the invention is intended to realize a situation in which the client can judge the evaluation about the merchandise or service appropriately.

The online shopping system of the present invention includes a server device for supplying merchandise or presenting service through a communication line, and client devices for purchasing the merchandise sold or the service presented from the server device through the communication line, comprising means for acquiring evaluation of the merchandise or service by the client having purchased the sold merchandise or presented service, and means for presenting the acquired evaluation or data based on the evaluation to other client, in which the evaluation is presented by the presenting means before the other client purchases the merchandise to be sold or the service to be presented from the server device through the communication line.

The acquiring means or the presenting means is connected to the communication line, and the evaluation is acquired or is presented through the communication line. Meanwhile, the acquiring means or presenting means is provided in the server device or settling device, or provided separately from the server device or settling device.

Further, the acquiring means allows the client to input the evaluation by using a display of the client device, and the evaluation is acquired in the acquiring means when the client inputs the evaluation. The acquiring means classifies the acquired evaluation in each merchandise or each service, or in each merchandise group or service group, and the presenting means presents the classified evaluation to the client device.

The server device includes means for noticing the merchandise content or service content of the sold merchandise or presented service to the client device, and the server device notices the evaluation together with the merchandise content or service content, or any one of the noticed merchandise content or service content or the noticed evaluation can be selected and reviewed by the other client. The server device may also disclose the source of the evaluation as being attached to the evaluation.

According to the present invention, the evaluation of the merchandise/service by the client having actually purchased the sold merchandise is acquired, and this evaluation is presented to other clients, so that the other clients may judge the evaluation of the merchandise appropriately.

### BRIEF EXPLANATION OF THE DRAWINGS

FIG. 1 is a block diagram of an online shopping system according to an embodiment of the invention.

FIG. 2 is an illustration showing video information transmitted by the merchandise information presenter in FIG. 1 to the client device.

FIG. 3 is an illustration showing video information transmitted by the merchandise information presenter in FIG. 1 to the client device.

FIG. 4 is an illustration showing video information transmitted by the information management device in FIG. 1 to the client device.

FIG. 5 is an illustration showing video information transmitted by the information management device in FIG. 1 to the client device.

FIG. 6A, FIG. 6B and FIG. 6C are illustrations showing video information transmitted by the merchandise information presenter, settling device and information management device in FIG. 1 to the client device.

FIG. 7 is an illustration showing video information transmitted by the merchandise information presenter in FIG. 1 to the client device.

FIG. 8 is an illustration showing video information transmitted by the conventional server device to the client device.

### PREFERRED EMBODIMENT OF THE INVENTION

Referring to the drawings, an embodiment of the invention is described below.

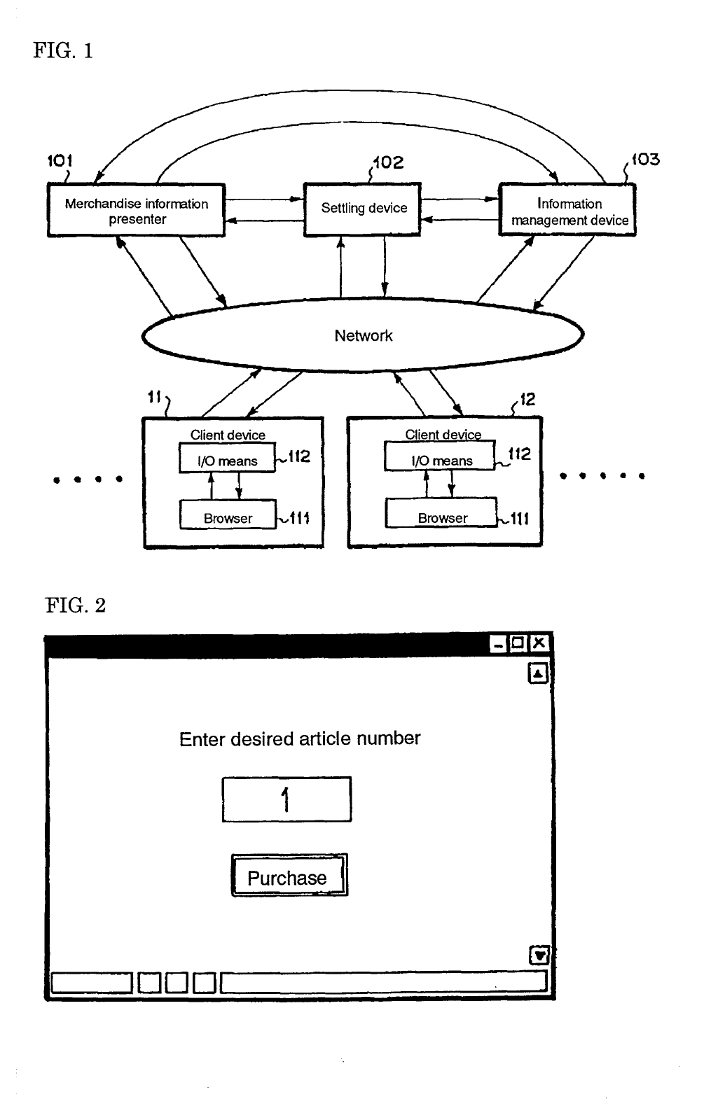

FIG. 1 is a block diagram of an online shopping system according to an embodiment of the invention. The online shopping system shown in FIG. 1 comprises a merchandise information presenter 101 which is a server device for showing a catalog of merchandise or service, describing the merchandise, and supplying the merchandise or presenting the service, an information management device 103 which acquires and receives the evaluation of the merchandise by the client having purchased the merchandise sold from the merchandise information presenter 101 and transmits this evaluation or the data on the basis of the evaluation to other clients, client devices 11, 12 which purchase the merchandise sold from the merchandise information presenter 101 on the basis of the merchandise catalog or evaluation by other clients on the merchandise, and present the evaluation of the purchased merchandise to the information management device 103, and a settling device 102 which settles the payment of purchase of the merchandise by the client.

The merchandise information presenter 101, information management device 103, settling device 102, and client devices 11, 12 are connected through a network 13 of communication line such as the Internet composed of public telephone line, ISDN line, etc., or the merchandise information presenter 101, information management device 103, and settling device 102 are connected, for example, through an exclusive line, so that data can be transmitted and received mutually.

Instead of connection through the network 13, the merchandise information presenter 101, information management device 103, and settling device 102 may be installed in one hardware, or the information management device 103 may be incorporated in the merchandise information presenter 101 or settling device 102.

The client devices 11, 12 comprise I/O means 112 for receiving various information transmitted from the merchandise information presenter 101, information management device 103, and settling device 102, issuing to a browser 111, and transmitting various information issued from the browser 111 to the merchandise information presenter 101, information management device 103, and settling device 102, and a browser 111 for displaying the home page opened by the merchandise information presenter 101 inputted from the I/O means 112 on a display device not shown, and issuing the client information and others inputted by the client to the I/O means 112.

The client devices 11, 12 are realized by, for example, personal computer (PC), cellular phone, mobile terminal and other transmitting and receiving machines comprising display means for displaying the information transmitted from the merchandise information presenter 101 and others, character input means for inputting at least character information to be transmitted to the merchandise information presenter 101 and others, and network means for connecting with the network 13.

The merchandise information presenter 101 stores a display program for displaying the image for input of client information, such as client name, address, telephone number, credit card account number and others, to the client. Similarly, the information management device 103 also stores a display program for displaying the image for input of evaluation of purchased merchandise to the client.

The settling device 102 is installed in a card firm office for settling payment of purchase of merchandise through the credit card, bank or postal office cash card, or debit card, and it receives client information transmitted from the client devices 11, 12 and merchandise information presenter 101 through the network 13, and settles the payment of the merchandise purchased by the client.

Of the client information, at least the credit card account number is encrypted by using SSL (secure socket layer) protocol, TLS (transport layer security) protocol or the like, and is transmitted and received through the network 13 in order to guarantee security.

In FIG. 1, two client devices 11, 12 are connected to one merchandise information presenter 101, but actually plural merchandise information presenters are connected through the network 13 aside from the merchandise information presenter 101, and plural client devices are connected through the network 13 aside from the client devices 11, 12.

FIG. 2 to FIG. 7 show displays on the monitor of, for example, the client device 11. Referring to FIG. 1 to FIG. 7, the operation of online shopping system of the embodiment is explained below.

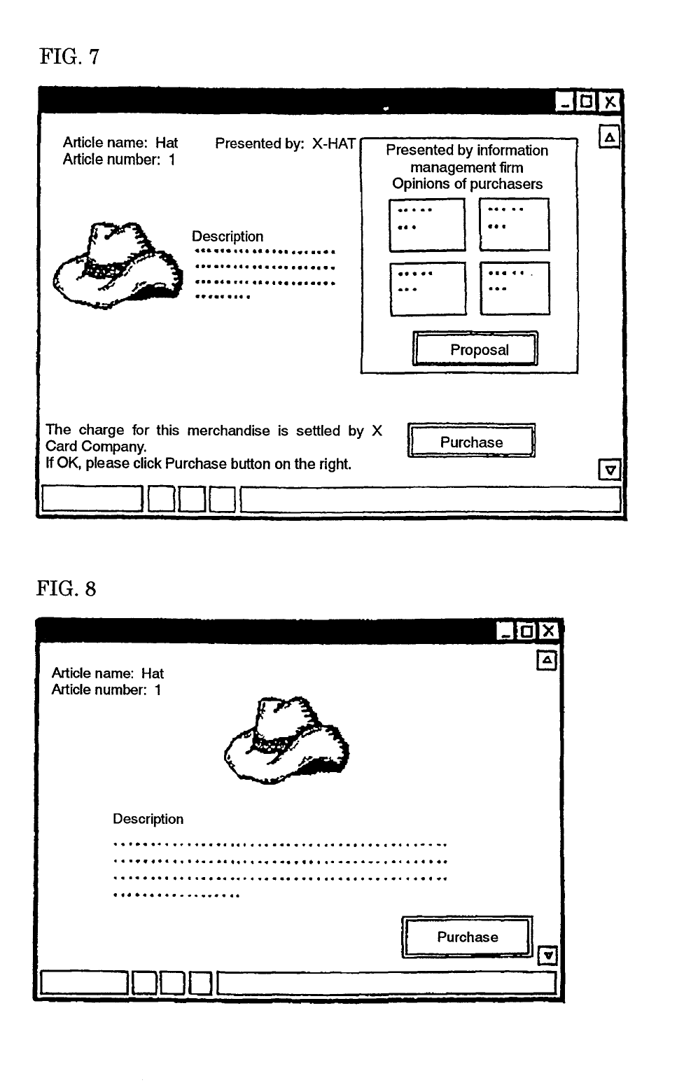

First, the merchandise supplier opens a home page by using the merchandise information presenter 101, and displays a catalog of merchandise sold on the home page. Thus, merchandise purchase orders are received through the network 13. That is, it is ready to start online shopping. As explained later, the merchandise catalog may be presented as video information as shown in FIG. 6, FIG. 6B, FIG. 6C and FIG. 7, or distributed by postal mail to the client separately, and herein an example of displaying the video information as shown in FIG. 6A,FIG. 6B, FIG. 6C and FIG. 7 is explained.

In a state ready for starting online shopping, when the client accesses the home page opened at the merchandise information presenter 101 side through the network 13 by using the client device 11 such as personal computer installed at home or in office, the data relating to the format of the video information used in the browser 111 of the client device 11 is transmitted to the merchandise information presenter 101.

As a result, in the merchandise information presenter 101, the format of the video information used in the browser 111 of the client device 11 is specified, and the video information of the merchandise catalog transformed into the format to be displayed in the browser 111 is transmitted to the client device 11. Specifically, if the browser 111 of the client device 11 is an HTML browser, the merchandise information transformed into the HTML format is transmitted to the client device 11.

As a result, for example, a merchandise catalog as shown in FIG. 7 is shown in the monitor or display unit of the client device 11. The merchandise/service catalog in FIG. 7 shows, as described later, aside from the video information of the article name, article number and article description, “Opinions of purchasers” of the corresponding article presented by the information management device 103, and home page of the settling device 102, and the client reviews the merchandise catalog, and selects an article to be purchased. The column of “Opinions of purchasers” includes the evaluation of the merchandise transmitted from the plural client devices not shown including the client device 12.

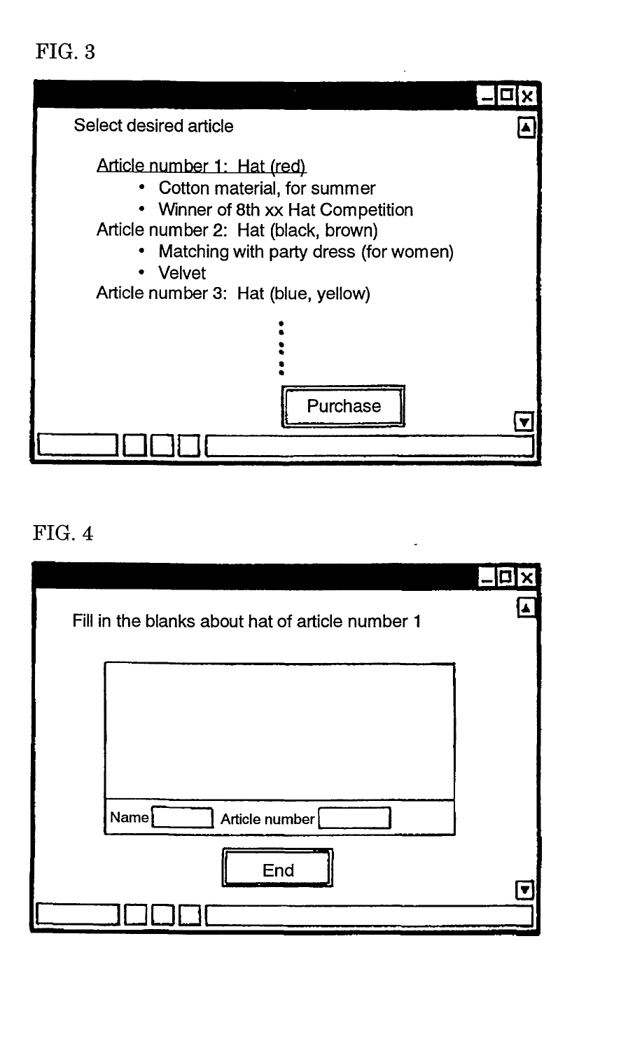

When the client finally decides the article to be purchased by referring to the displayed merchandise catalog, the article number in the catalog is inputted according to the video information guide shown in FIG. 2, or the desired article is selected by clicking the corresponding article number according to the video information guide shown in FIG. 3, and Purchase button is clicked. As a result, the selection information is issued from the browser 111 to the I/O means 112, and the I/O means 112 transmits the information to the merchandise information presenter 101.

The information transmitted from the client device 11 side to the merchandise information presenter 101 includes an identification number individually assigned to the client device 11, and by this number, at the merchandise information presenter 101 side, it is distinguished the information is transmitted from which client device.

When receiving the article number of the merchandise to be purchased by the client is received, the merchandise information presenter 101 transmits the video information to the client device 11. At the client device 11, the information is received in the I/O means 112, and is issued to the browser 111. The monitor of the client device 11 shows the video information for inputting client information by the browser 111.

According to the video information guide, the client inputs the client information including the name, address and telephone number, and the client information is transmitted to the merchandise information presenter 101 side from the browser 112 and I/O means 111 through the network 13.

Consequently, for example, the merchandise information presenter 101 requests the settling device 102 to settle according to the purchase amount of the merchandise by the client. Receiving the request, the settling device 102 settles the payment of the purchase amount by drawing from the bank account or postal account registered in the credit card account number. When settlement of payment of purchase amount is over, its completion is noticed to the merchandise information presenter 101.

Meanwhile, the settling device 102 inquires a credit assurance firm not shown about the credit card balance status according to the credit card account number inputted by the client, and if delinquency is found, online shopping by this particular client can be banned directly or through the merchandise information presenter 101.

Receiving completion notice of settlement from the settling device 102, the merchandise information presenter 101 ships the merchandise to the client by postal or other delivery, transmits the process to the information management device 103 together with the client information of purchase of merchandise and article number, and terminates the online shopping.

Instead of providing the settling device 102 on the network 13, when supplying the merchandise to the client from the merchandise/service information presenter 101, by attaching the bill to the merchandise, the client receiving the bill may pay the amount of purchase by using cash card or debit card at the bank or debit card firm.

When the client receiving the purchased merchandise accesses the information management device 103 from the client device 11 through the network 13, the image as shown in FIG. 4 appears on the monitor of the client device 11, and the client enters the evaluation about the “hat” of article number 1 of purchase, and name and article number according to the screen guide, and clicks End button, so that the evaluation about “hat” is transmitted to the information management device 103 through the browser 111 and I/O means 112.

Thus, in the information management device 103, the evaluation about the “hat” of article number 1 purchased by the client is obtained. The information management device 103 is not always required to be connected to the network 13, for example, when receiving the merchandise shipping notice from the merchandise information presenter 101, information may be transmitted to the client by other route than the network 13, such as postal mailing.

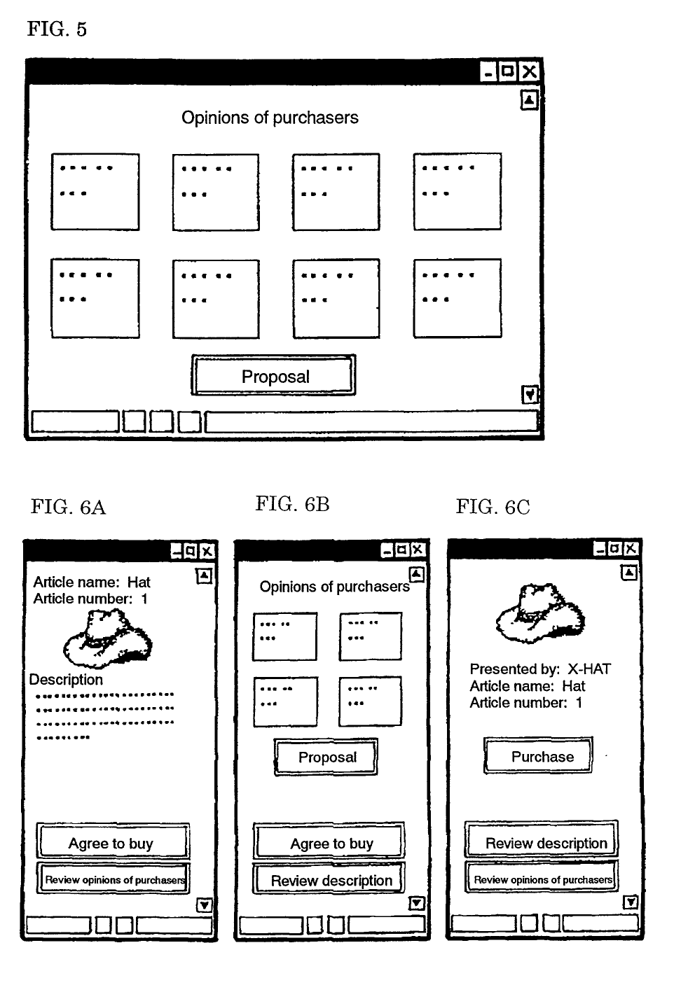

In the information management device 103, the received client evaluation is exhibited in the column of “Opinions of purchasers” together with the client's name, for example, as shown in FIG. 5 and FIG. 6B. In the column of “Opinions of purchasers” in FIG. 5, the evaluation about the merchandise by users of other client devices not shown as well as the client device 12 is displayed. The information management device 103 may summarize the evaluation transmitted from clients, list the evaluation in “Opinions of purchasers” if the transmitted evaluation is contrary to the social order, or investigate the satisfaction about the merchandise and display in a graph.

Herein, in addition to the evaluation of the “hat” of article number 1 of purchase, the name and article number must be transmitted to the merchandise management device 103, and therefore only the client actually having purchased the merchandise can transmit the evaluation about the purchased merchandise only, so that the reliability of source of “Opinions of purchasers” and evaluation is guaranteed. Incidentally, for example, if the merchandise information presenter 101 provides each client with an individual identification number, instead of mentioning the name directly in “Opinions of purchasers”, a nickname or the like may be used.

On the other hand, if the information management device 103 judges that the input of name or article number is wrong, the reliability of evaluation about the “hat” is low, and hence such evaluation may not be listed in the “Opinions of purchasers.”

Further, when the client clicks Proposal button shown in FIG. 5, a screen as shown in FIG. 4 appears on the display of the client device 11, and proposal for new merchandise can be sent to the information management device 103. Thus, the client having purchased the merchandise can present the own evaluation about the merchandise to other prospective purchasers.

FIG. 6 A, FIG. 6B, FIG. 6C and FIG. 7 are illustrations showing video information of merchandise catalog. Specifically, in FIG. 6A, the video information of the article, article number and description of the merchandise, “Opinions of purchasers” (FIG. 6 B) on the merchandise presented by the information management device 103, and the video information (FIG. 6C) of home page of the settling device 102 or the like are linked, and it is shown that the display can be changed over by selecting any one of them. The client can also look through all of these video information shown in FIG. 6 A, FIG. 6B and FIG. 6C.

FIG. 7 shows a batch display of the video information shown in FIG. 6 A to FIG. 6C on the monitor of the client device 11, and of the video information shown in FIG. 7, the images corresponding to FIG. 6 B and FIG. 6C are those presented by the information management device 103 and settling device 102 to the merchandise information presenter 101, and the source is indicated, for example, by the merchandise information presenter 101.

In order that the merchandise information presenter 101 may transmit the video information as shown in FIG. 7 to the client device 11, the settling device 102 transmits the video information corresponding to FIG. 6B and FIG. 6C to the merchandise information presenter 101 through the network 13 or exclusive line periodically or according to the request from the merchandise information presenter 101.

When the video information as shown in FIG. 6A to FIG. 6C or FIG. 7 is displayed on the monitor of the client device 11, if the client wishes to purchase the “hat” of article number 1, aside from the merchandise description, the client can also refer to the evaluation of other clients on the “hat” of article number 1. Thus, an objective reference for buying the merchandise is given to the client.

Or, the information management device 102 presenting the opinions of purchasers of the merchandise may be provided on the network 13 independently of the merchandise information presenter 101 installed at the provider of the merchandise, the merchandise description presented by the merchandise information presenter 102 (101) and the opinions of other clients presented by the information management device 102 can be compared, so that the client can judge the evaluation of the merchandise more adequately.

In FIG. 6 A to FIG. 6C and FIG. 7, the merchandise explanation of the “hat” of article number 1 and “Opinions of purchasers” on the merchandise are presented, but as shown in FIG. 3, for example, in the merchandise group of “hats” and individual merchandise description, “Opinions of purchasers” about the merchandise group may be presented, and whether in merchandise or in merchandise group, “Opinions of purchasers” for all merchandise presented by the merchandise information presenter 101 may be displayed.

In the case of display of “Opinions of purchasers” about all merchandise presented by the merchandise information presenter 101, for example, by inputting the name of the merchandise, it is preferred to have a retrieval function for searching the merchandise relating to the name.

In the embodiment, the client receiving the purchased merchandise accesses the information management device 103 through the network 13 from the client device 11, but when the information management device 103 receives the merchandise shipping notice from the merchandise information presenter 101, it may be designed to display the image as shown in FIG. 4 in the client device 11 afterwards, for example, three days later when it is supposed that the purchased merchandise is shipped to the client.

What is claimed is:

1. An online shopping system which comprises:
a server device for supplying merchandises or services through a network;
a plurality of client devices for purchasing said merchandises or services through said network;
acquiring means connected with said network for acquiring an evaluation of said merchandise or service by a client who has purchased said merchandise or service, and
presenting means connected with said network for presenting to other client said evaluation or data on the basis of said evaluation,
wherein said evaluation is presented through said network to said other client, before said other client purchases said merchandise or service.

2. The online shopping system according to claim 1, which further comprises a settling device connected with said network for a payment of price of said merchandise or service.

3. The online shopping system according to claim 1, wherein said server device or said settling device comprises said acquiring means or presenting means.

4. The online shopping system according to claim 1, wherein said server device and said settling device comprises said acquiring means and presenting means, respectively, or said server device and said settling device comprises said presenting means and acquiring means, respectively.

5. The online shopping system according to claim 1, wherein said acquiring means allows said client who has purchased said merchandise or service to input said evaluation.

6. The online shopping system according to claim 1, wherein:
said acquiring means classifies said evaluation per merchandise or service, or per merchandise group or service group; and
said presenting means presents said evaluation to said client device.

7. The online shopping system according to claim 1, wherein said server device includes means for notifying said client of contents of said merchandises or services.

8. The online shopping system according to claim 7, wherein said server device notifies said client of said evaluation together with said contents.

9. The online shopping system according to claim 7, wherein either of said contents or said evaluation is selected by other clients.

10. The online shopping system according to claim 8, wherein said server device notifies said client of a source of evaluation.

11. The online shopping system according to claim 1, wherein said network is Internet.

12. A server device used in an online shopping system having a server device for supplying merchandises or services through a network, and a plurality of client devices for purchasing said merchandise or service through said network, which comprises:
acquiring means for acquiring an evaluation of said merchandise or service by a client who has purchased said merchandise or service; and
presenting means for presenting to other clients said evaluation or data on the basis of said evaluation,
wherein said evaluation is presented, before said other clients purchases said merchandise or service.

13. The server device according to claim 12, wherein said acquiring means or said presenting means is connected to said network, and said evaluation is acquired or presented through said network.

14. A client device used in an online shopping system having a server device for supplying merchandises or services through a network, and a plurality of client devices for purchasing said merchandise or service through said network, which comprises:
acquiring means for acquiring an evaluation of said merchandise or service by a client who has purchased said merchandise or service.

15. The client device according to claim 14, wherein said acquiring means acquires said evaluation through said network.

16. An information management device which comprises:
acquiring means for acquiring an evaluation of said merchandise or service by a client who has purchased said merchandise or service; and
presenting means for presenting to other client device said evaluation or data on the basis of said evaluation.

17. The information management device according to claim 16, wherein said acquiring means or said presenting means acquires or presents said evaluation through said network.
